(19) United States
(12) Patent Application Publication
(10) Pub. No.: US 2022/0258062 A1
(43) Pub. Date: Aug. 18, 2022

(54) 4D SCREEN SHOOTING RANGE AND PLAYING METHOD USING THEREOF

(71) Applicant: NSPARK INC., Seoul (KR)

(72) Inventor: No Sun PARK, Seoul (KR)

(21) Appl. No.: 17/674,130

(22) Filed: Feb. 17, 2022

(30) Foreign Application Priority Data
Feb. 18, 2021 (KR) 10-2021-0021540

(51) Int. Cl. A63F 13/837; A63F 13/27; A63F 13/53; A63F 13/219; A63F 13/428; A63F 13/213; A63F 13/285; A63F 13/24; A63F 13/792

(52) U.S. Cl. CPC A63F 13/837; A63F 13/27; A63F 13/53; A63F 13/219; A63F 13/428; A63F 13/213; A63F 2300/8082; A63F 13/24; A63F 13/792; A63F 2300/303; A63F 2300/8023; A63F 2300/8076; A63F 13/285

(57) ABSTRACT

The present invention provides a 4D screen shooting range, which includes: a wall body forms a shooting space having a predetermined size, and has an entrance formed in any portion thereof; a screen installed on the wall body by avoiding the entrance and aimed or pointed at with a personal weapon held by a user; a projection unit configured to project an image onto the screen according to a shooting game content selected by the user; a shooting zone formed by including a center of the shooting space on the floor in a predetermined size with being spaced apart from the screen, in which a setting box operated to set a shooting game according to a selection of the user is disposed; and an action structure disposed in the shooting space to add a producing effect to a shooting game content image selected by the user.

### CROSS REFERENCE TO RELATED APPLICATIONS

This application claims the priority benefit of Korean Patent Application No. 10-2021-0021540 filed on Feb. 18, 2021, the entirety of which is incorporated by reference herein.

### BACKGROUND OF THE INVENTION

### 1. Field of the Invention

The present invention relates to a 4D screen shooting range and playing method using thereof to play a screen shooting game.

### 2. Description of the Related Art

Recently, according to the development of multimedia techniques and computer programming techniques, virtual experiences that simulate real situations which are difficult to implement in real situations and allow users to experience various situations in advance while having the same feeling as in real situations in a virtual space are very popular.

In the virtual space simulated in the same conditions as in the real situation, in particular, aircraft training, indoor driving practice, or the like is performed. Also, in the sports field, sport players may perform training in the virtual space, thereby training based on accurate data is possible.

In addition, in the game or sport fields, users may experience situations that cannot be produced in real situations through virtual experiences by the multimedia and computer techniques.

As described above, the virtual reality education by a simulator allows users to experience situations that are difficult to directly produce in real situations, and is often used to develop the ability to respond appropriately when a real situation occurs.

Recently, in addition to the virtual reality experience, an indoor screen game device has been developed which allows users to enjoy various exercises and games indoors through a projection screen closely similar to the real ones without going to the actual field for exercise or play games in relation to the simulator. Examples of such a device may include an indoor screen golf game, a screen baseball game, a screen dance game, a screen shooting game and the like.

Among them, in the indoor screen shooting game device, a user shoots at a target projected onto the screen by methods including, for example, firing a light bullet such as an infrared laser beam or detecting an image of a specific point projected onto the screen. In such the screen shooting game device, one or a plurality of users play a game using a given game gun at a designated position facing the screen.

Korean Patent Registration Publication No. 10-1816994 (published on Jan. 10, 2018, hereinafter referred to as Patent Document 1) relates to a screen shooting system including a difficulty selection device which allows users to directly set the game difficulty and control the competition and score acquisition by themselves through differential distribution of scores.

However, Patent Document 1 discloses a two-dimensional screen shooting game in which a user shoots a bullet at a target by aiming a weapon held by the user on the screen and pulling a trigger. Since the user only looks at the screen and it is difficult to move around, there is a problem in that it cannot give satisfaction to users who prefer more dynamic motions like survival games or actual battles.

### PRIOR ART DOCUMENT

### Patent Document

(Patent Document 0001) Korean Patent Registration Publication No. 10-1816994

### SUMMARY OF THE INVENTION

In consideration of the above-described circumstances, it is an object of the present invention to provide a screen shooting range and playing method using thereof, which allow users to enjoy a three-dimensional and complex shooting game through motion like actual battles using various action structures and a plurality of screens, rather than a two-dimensional game in which users play a shooting game while looking at only one screen.

Another object of the present invention is to provide a screen shooting range and playing method using thereof, which allow users to enjoy a more realistic shooting game by appearing a target along with the motion of various action structures.

In addition, another object of the present invention is to provide a screen shooting range and playing method using thereof, which allow users to enjoy various shooting games by forming a shooting space depending on various themes according to the selection of the users.

Further, another object of the present invention is to provide a screen shooting range and playing method using thereof, which do not require washing, unlike a survival game that requires washing of equipment once used.

Furthermore, another object of the present invention is to provide a screen shooting range and playing method using thereof, in which users may perform not only a shooting game on the ground but also an anti-aircraft shooting game by arranging setting boxes in a shooting zone including a center of the floor of a shooting space, and perform shooting games of various contents by covering themselves during the shooting game through the setting boxes.

To achieve the above objects, according to an aspect of the present invention, there is provided a 4D screen shooting range including: a wall body which includes wall surfaces, a ceiling and a floor to form a shooting space having a predetermined size, and has an entrance formed in any portion of the wall surface; a screen installed on the wall body by avoiding the entrance and aimed or pointed at with a personal weapon held by a user; a projection unit configured to project an image onto the screen according to a shooting game content selected by the user; a shooting zone formed by including a center of the shooting space on the floor in a predetermined size with being spaced apart from the screen, in which a setting box operated to set a shooting game according to a selection of the user is disposed; and an action structure disposed in the shooting space to add a producing effect to a shooting game content image selected by the user.

In the 4D screen shooting range according to an embodiment of the present invention, a plurality of the screens may be each formed in a flat surface and disposed perpendicular to the floor, and the plurality of screens may be connected with each other so that the plurality of screens form a polygonal shape as seen in a plan view.

In the 4D screen shooting range according to an embodiment of the present invention, a plurality of the screens may be each formed in a concave curved surface and disposed perpendicular to the floor, and the plurality of screens may be connected with each other so that the plurality of screens form a circle or an ellipse shape as seen in a plan view.

In the 4D screen shooting range according to an embodiment of the present invention, the setting box may include: a personal weapon holder on which a personal weapon is placed; and a vibration suit holder on which a vibration suit to be worn by the user is placed.

In the 4D screen shooting range according to an embodiment of the present invention, the setting box may be charged in a wireless or wired manner while the personal weapon and the vibration suit are placed.

In the 4D screen shooting range according to an embodiment of the present invention, the setting box may play a role of a cover for the user when performing the shooting game.

In the 4D screen shooting range according to an embodiment of the present invention, the setting box may include: a detection sensor configured to detect a motion and a position of the user; and a vibration motor housed inside to produce a vibration effect when an object is fired according to the projected image.

In the 4D screen shooting range according to an embodiment of the present invention, the setting box may be changed in a size, height, or position according to the contents of the shooting game selected by the user or the progress of the contents.

In the 4D screen shooting range according to an embodiment of the present invention, the setting box may include: a control lever configured to aim an aiming target projected onto the screen; a button configured to send an instruction to attack the aiming target when being pressed by the user; and a head-up display made of a transparent material in a plate shape and disposed parallel to any one surface of the wall body, such that the user sees the screen, wherein aiming at any one object of the images projected onto the screen is identified through the control lever or information on subjects including the aiming object is identifiably displayed thereon.

In the 4D screen shooting range according to an embodiment of the present invention, the head-up display may include: at least one pair of acrylic plates spaced apart from each other in parallel; and LED lights installed on one side of the setting box between the pair of acrylic plates, so as to be turned on to produce an effect of indicating that the object is fired or a crisis situation occurs with a plurality of colors.

According to an embodiment of the present invention, the 4D screen shooting range may further include a drone which is disposed in the shooting space and operated through a control lever and a button.

In the 4D screen shooting range according to an embodiment of the present invention, the operation of the drone using the control lever and the button may be identified by the user through the head-up display.

In the 4D screen shooting range according to an embodiment of the present invention, the setting box may include a pedal which is formed at a lower side thereof and pressed by the user to fire a bullet from the weapon or load bullets into a weapon.

In the 4D screen shooting range according to an embodiment of the present invention, the setting box further may include, at the lower side thereof: a brush installed at a height corresponding to a user's ankle and configured to touch the user's ankle by rotating; and a brush rotation motor connected to rotate the brush.

In the 4D screen shooting range according to an embodiment of the present invention, the setting box further may include: a hole-punched plate in which punched holes are formed in any portion thereof; and a fog machine provided inside the setting box to generate a fog for producing a dispersion effect of dust or fog, wherein the fog is sprayed through the punched holes.

In the 4D screen shooting range according to an embodiment of the present invention, the fog sprayed through the punched holes of the fog machine may include a disinfectant solution.

In the 4D screen shooting range according to an embodiment of the present invention, the shooting zone may include: a footrest disposed on the floor and pressed according to the motion of the user; and a pressure sensor disposed in the footrest or on a lower side of the footrest to detect a moving direction or a speed of the user.

In the 4D screen shooting range according to an embodiment of the present invention, the image projected onto the screen may be changed in response to the moving direction or the speed of the user detected by the pressure sensor, thus to reflect the motion and a viewpoint of the user.

In the 4D screen shooting range according to an embodiment of the present invention, the footrest may include a vibrating means configured to generate a vibration in response to a producing effect of the image projected onto the screen.

In the 4D screen shooting range according to an embodiment of the present invention, the personal weapon may include: a button or a selector lever operated by the user to select and change firing types in response to a plurality of weapons included in the shooting game contents.

In the 4D screen shooting range according to an embodiment of the present invention, the personal weapon may include a recoil means configured to be recoiled in response to firing and throwing.

According to an embodiment of the present invention, the 4D screen shooting range may further include: a photographing camera installed on any portion of the wall body to photograph a game process of the user; and a storage unit provided outside the shooting space to store an image photographed by the photographing camera.

In the 4D screen shooting range according to an embodiment of the present invention, the action structure may include different types of structures, and may be moved, operated and destroyed according to preset contents in the shooting game.

According to an embodiment of the present invention, the 4D screen shooting range may further include an unmanned payment means arranged inside or outside the shooting space to allow the user to perform a payment as a prerequisite for playing the shooting game.

Further, according to another aspect of the present invention, there is provided playing method of using a 4D screen shooting range, the method including: a first payment step of performing a payment through an unmanned payment means; an entry step of entering a shooting space after the first payment step; an equipment wearing step of acquiring and wearing a vibration suit and a personal weapon disposed in a setting box after the entry step; a game selection step of selecting any one of shooting game contents prepared through the setting box after the equipment wearing step; a game start step of executing the selected shooting game and starting to play the game by a user after the game selection step; a game end step of ending the shooting game after the game starting step; an equipment return step of placing the vibration suit and personal weapon in the setting box after the game end step; a result confirmation step of visually confirming results of the shooting game after the equipment return step; and a result provision step of providing an image and results of the shooting game after the result confirmation step.

According to an embodiment of the present invention, the method may further include a user confirmation step of confirming whether the user wants to login between the first payment step and the entry step.

According to an embodiment of the present invention, the method may further include: a member enrollment guide step of guiding a member enrollment procedure and benefits, when the user does not perform login; and a member enrollment determination step of determining whether the user enrolls as a member after the member enrollment guide step.

According to an embodiment of the present invention, the method may further include a member enrollment step of enrolling as a member online when the user wants to enroll as the member.

According to an embodiment of the present invention, the method may further include a determination step of determining whether to continue or stop the shooting game after the game end step.

According to an embodiment of the present invention, the method may further include a second payment step of performing a payment through an unmanned payment means, if it is determined that the user wants to continue the shooting game; and proceeding to the game selection step of selecting a game after the second payment step.

According to an embodiment of the present invention, the method may further include a mileage accumulation step of receiving and accumulating a mileage corresponding to the results of the game after the game ends by the logged in user; wherein the mileage is used to purchase items, converted to free tickets, or exchanged with prizes.

According to the present invention, the users may enjoy a three-dimensional and complex shooting game through motion like actual battles using various action structures and a plurality of screens, rather than a two-dimensional game in which users play a shooting game while looking at only one screen, and enjoy a more realistic shooting game by appearing a target along with the motion of various action structures.

In addition, according to the present invention, since the shooting space is formed depending on various themes according to the selection of the users, the users may enjoy various shooting games according to the ages and preferences of the users.

Further, according to the present invention, there is no need to wash equipment, unlike a survival game that requires washing of equipment once used, and there is no need to wear equipment such as various types of survival games, such that game equipment may be conveniently managed.

Furthermore, according to the present invention, the users may perform shooting games of various contents through the setting boxes.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view illustrating the concept of a 4D screen shooting range according to an embodiment of the present invention as seen an inside from an outside;

FIG. 2 is a plan view illustrating the concept of FIG. 1 as seen from a top;

FIG. 3 is a perspective view illustrating the concept of FIG. 1;

FIGS. 4A to 4C are a front view, a side view, and a rear view illustrating the concept of a setting box installed in the 4D screen shooting range according to an embodiment of the present invention;

FIG. 5 is a view illustrating aiming using a drone in the 4D screen shooting range according to an embodiment of the present invention;

FIG. 6 is a view illustrating the motion of a brush in the 4D screen shooting range according to an embodiment of the present invention;

FIGS. 7A and 7B are views illustrating the concept of motion of a rotating structure provided in the setting box installed in the 4D screen shooting range according to an embodiment of the present invention;

FIGS. 8A to 8C are views illustrating examples of motion of action structures in the 4D screen shooting range according to an embodiment of the present invention;

FIG. 9 is a view illustrating an example in which game selection modes are displayed on a screen when using the 4D screen shooting range according to an embodiment of the present invention;

FIG. 10 is a view illustrating an example in which game results are displayed on the screen after the game ends when using the 4D screen shooting range according to an embodiment of the present invention; and

FIGS. 11A and 11B are flowcharts illustrating a procedure of playing method of using a 4D screen shooting range according to an embodiment of the present invention

### DETAILED DESCRIPTION OF THE INVENTION

Hereinafter, embodiments will be described in detail with reference to the accompanying drawings. In denoting reference numerals to components of respective drawings, it should be noted that the same components will be denoted by the same reference numerals although they are illustrated in different drawings. Further, in description of preferred embodiments of the present invention, the publicly known functions and configurations related to the present invention, which are judged to be able to make the purport of the present invention unnecessarily obscure will not be described in detail.

In addition, in describing components of the present invention, the terms first, second, A, B, (a), (b), and the like, may be used. These terms are intended to distinguish the components from other components, and do not limit the nature, sequence or order of the components. It will be understood that when a component is described to as being “connected”, “combined” or “coupled” to another component, the component may be directly connected or coupled the another component, but it can be “connected”, “combined” or “coupled” to the another component intervening another component may be present.

Hereinafter, a 4D screen shooting range according to an embodiment of the present invention will be described with reference to the accompanying drawings.

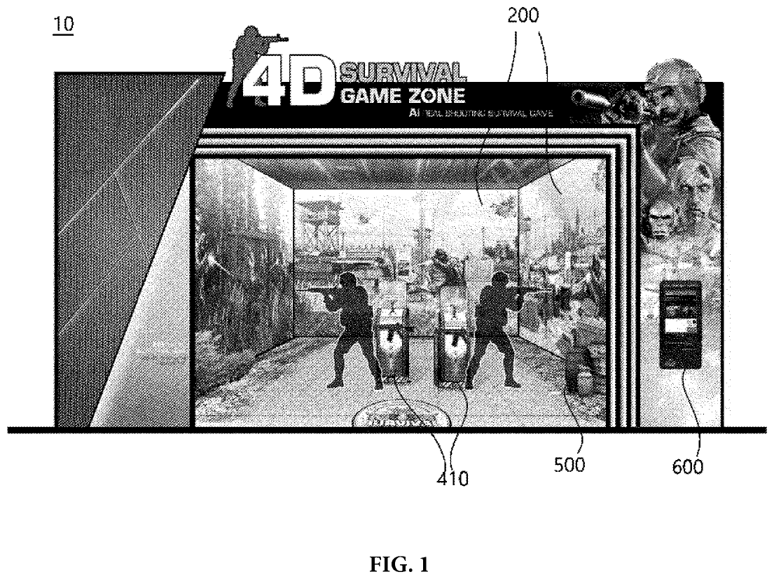

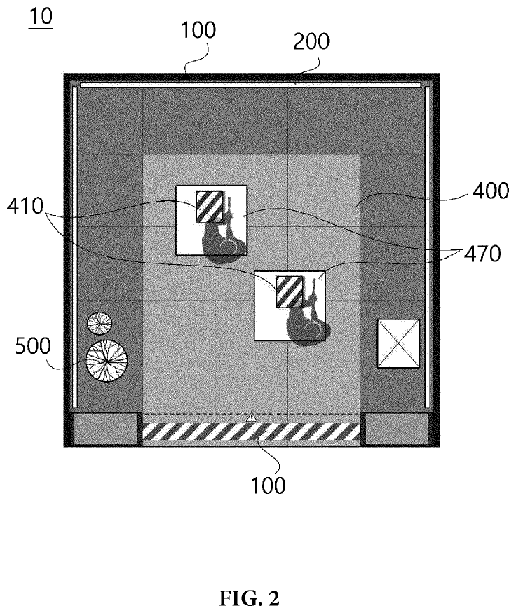

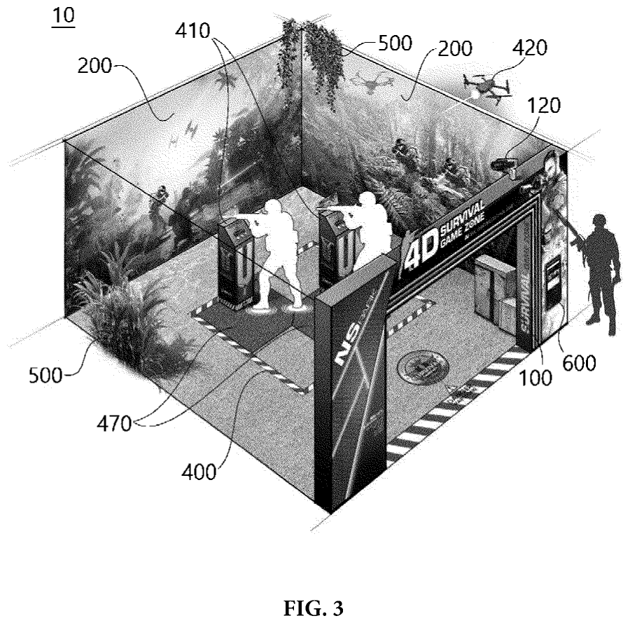

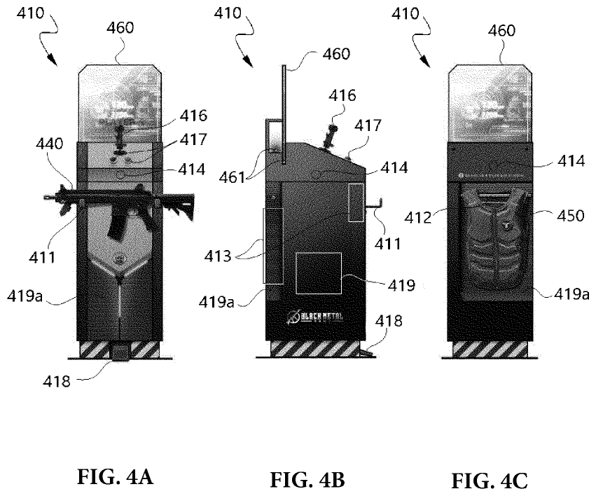

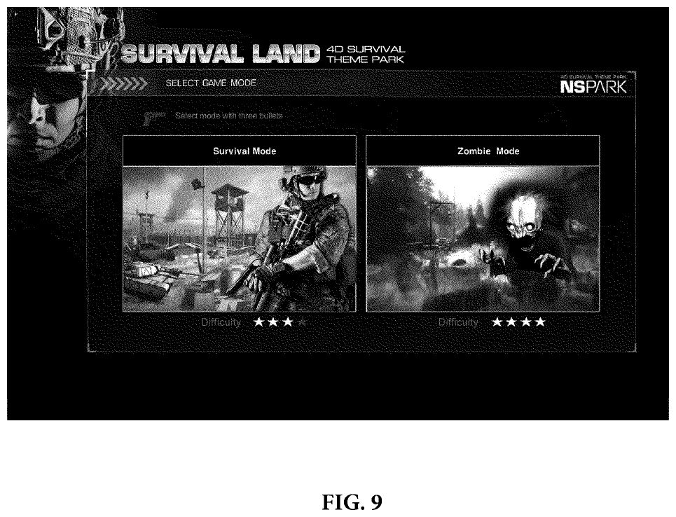

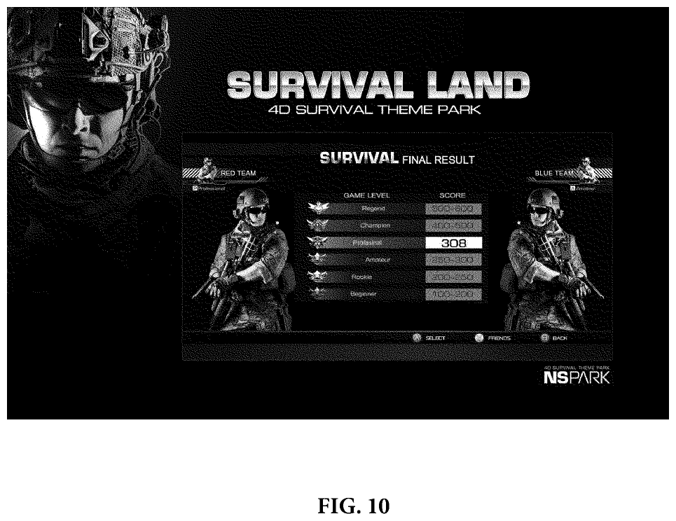

FIG. 1 is a view illustrating the concept of a 4D screen shooting range according to an embodiment of the present invention as seen an inside from an outside, FIG. 2 is a plan view illustrating the concept of FIG. 1 as seen from a top, FIG. 3 is a perspective view illustrating the concept of FIG. 1, FIGS. 4A to 4C are a front view, a side view, and a rear view illustrating the concept of a setting box installed in the 4D screen shooting range according to an embodiment of the present invention, FIG. 9 is a view illustrating an example in which game selection modes are displayed on a screen when using the 4D screen shooting range according to an embodiment of the present invention, and FIG. 10 is a view illustrating an example in which game results are displayed on the screen after the game ends when using the 4D screen shooting range according to an embodiment of the present invention.

Referring to FIGS. 1 to 3, a 4D screen shooting range 10 according to an embodiment of the present invention may include a wall body 100, a screen 200, a projection unit (not illustrated), a shooting zone 400 and an action structure 500.

The wall body 100 may form a shooting space having a predetermined size. That is, a closed figure may be formed by connecting a plurality of wall bodies 100 with each other, thus to define the shooting space. The shooting space is formed in a square shape as seen in a plan view, but it is not limited thereto, and a plurality of wall bodies 100 may be configured so that the shooting space is formed in a polygonal shape. In addition, the wall body 100 may be formed in a curved shape whose one surface in contact with the shooting space has a curvature.

An entrance 110 may be formed in any portion of the wall body 100. In this case, the entrance 110 may be an open type, or a closed type in which a door is installed. For reference, a blind projection unit (not illustrated) may be installed on the wall body 100 to cover the entrance 110.

A photographing camera 120 may be installed on the wall body 100. The photographing camera 120 may photograph a process of playing a game by a user, and the photographed image may be stored in a storage unit (not illustrated) provided outside the shooting space.

The screen 200 may be installed on the wall body 100. An image is projected onto the screen 200 by the projection unit (not illustrated), which will be described below, and in this state, the user may aim or point to a virtual object in the image with a personal weapon 440 held by the user.

A plurality of screens 200 may be vertically disposed on the floor. By directly projecting the image onto the wall body 100, by the projection unit (not illustrated) to be described below, the wall body 100 itself may play a role of the screen 200, but it is not limited thereto.

Referring to FIG. 2, although three screens 200 are shown to be arranged spaced apart from each other, a plurality of screens 200 may be arranged to be connected with each other, and one screen 200 formed in a polygonal shape may be provided.

The screen 200 may be provided to be spaced apart from the wall body 100 corresponding to the wall body 100. That is, the screen 200 may be provided by being spaced apart from one surface of the wall body 100 in parallel thereto, or by being adhered or attached to the wall body 100. For reference, as seen in a plan view, the plurality of screens 200 may form a polygonal shape. The screens are illustrated as having a space of a rectangular parallelepiped in a plane view in the drawings, but this is only an example for describing an embodiment of the present invention, and the screens may form a space having various polygonal shapes according to the intention of a manufacturer without limitation thereof. In this case, when the screens 200 and the wall bodies 100 correspond one-to-one, each of the plurality of wall bodies 100 may be formed to correspond to each of the plurality of screens 200, but may vary according to the intention of the manufacturer. For example, it is also possible to provide the screen 200 formed in a hexagonal shape in the plan view on the wall body 100 formed in pentagonal shape in the plan view. In addition, the screen 200 may have one concave curved surface such as a circle or an ellipse corresponding to the wall body 100 having a concave curved surface.

An image prepared in advance according to contents of the shooting game selected by the user may be projected onto the screen by the projection unit (not illustrated). Although the screen is not illustrated in the drawings, a projection means such as a beam projector capable of projecting an image may be provided on an upper portion of the shooting space as the projection unit. In addition, a screen such as a wall-mounted TV or LED billboard whose screen 200 projects an image may be disposed as the projection unit in addition to the projection means.

The shooting zone 400 is formed by including a center of the shooting space. The shooting zone 400 may be spaced apart from the screen by a predetermined distance and formed on the floor in a predetermined area. The shooting zone 400 may be provided with a setting box 410 and a footrest 470.

Referring to FIG. 3 and FIGS. 4A to 4C, the setting box 410 may be provided three-dimensionally by protruding upward from the floor. The setting box 410 may be changed in size, height, or position thereof according to setting of the user. The user may operate the setting box 410 to set the shooting game by selection. For example, before starting the shooting game, the user may operate the setting box 410 to set a game mode, an arrangement of an action structure 500, a size of the sound, etc., which will be described below. In addition, the setting box 410 may play a role of a cover for the user when performing the shooting game (see FIG. 2).

The setting box 410 may be provided with a personal weapon holder 411 on the front surface thereof. The personal weapon holder 411 is configured to hold the personal weapon 440 to be used in the shooting game, and although a pair of supports are illustrated in the drawings, it is not limited thereto, and mounting methods to which various configurations are applied may be used.

The setting box 410 may be provided with a vibration suit holder 412 on a side or rear surface thereof. The vibration suit holder 412 is configured to hold a vibration suit 450 to be used in the shooting game, and is illustrated by being provided as a horizontal bar in the drawings, but it is not limited thereto, and mounting methods in which various configurations are applied may be used.

Although not illustrated in the drawings, the personal weapon 440 and the vibration suit 450 may be operated in a wired or wireless manner. In addition, the personal weapon 440 and the vibration suit 450 may be provided with separate chargers so as to be operated to produce an effect related to an image projected onto the screen 200.

For example, the user may aim the personal weapon 440 at the target on the screen 200, and when the user pulls a trigger to fire a bullet toward the aiming object, the bullet is fired from the projected image, such that producing effects, in which the aiming target is fired by the bullet or the aiming target is misfired, may appear. In this case, by pulling the trigger, a sensor (not illustrated) provided in the setting box 410 detects this condition such that producing an effect of shooting may appear on the screen 200. For reference, the personal weapon 440 may include a selector lever (not illustrated) and a recoil means (not illustrated). The selector lever may be operated by the user to select and change firing types in response to a plurality of weapons included in the shooting game contents, respectively. The user may select one of a single shot, a burst, and continuous fire for the firing type of bullets through the selector lever, and may also select the type of weapon.

The recoil means is capable of recoiling in response to firing and throwing. Depending on the type of shot and weapon selected through the selection of the selector lever by the user, the recoil form by the recoil means may be changed. For example, when the user sets the selector lever to the continuous fire, the recoil means may generate a recoil that is gradually strengthened, and the accuracy rate may be decreased due to the recoil that is gradually strengthened. In addition, when the user sets the selector lever to a shotgun or machine gun, the recoil means may generate a more heavy recoil in response to the shotgun or machine gun than the case of the rifle.

The vibration suit 450 may have a vibrating means (not illustrated) equipped therein, and when a user is damaged by an enemy in an image projected after the user wears the suit, the vibration suit 450 may be vibrated by the vibrating means so that the user can feel the vibration. In this case, the vibration suit 450 may be controlled in terms of the vibration position and intensity in response to the damage position and amount of damage suffered by the user.

Herein, a charger is provided inside the personal weapon 440 and the vibration suit 450 to operate the recoil means of the personal weapon 440 and the vibrating means of the vibration suit 450, respectively. In order to enable charging of power to the charger, wireless charging units 413 may be placed inside the setting box 410 with being located close to the front and rear surfaces of the setting box 410, respectively. That is, the personal weapon 440 and the vibration suit 450 should supply power to the built-in recoil and vibrating means according to their use. If the personal weapon 440 and the vibration suit 450 are placed on the personal weapon holder 411 and the vibration suit holder 412, the personal weapon 440 and the vibration suit 450 may be charged in a wireless manner. However, the charger may charge them in a wired manner using a separate power line.

The setting box 410 may include a detection sensor 414. The detection sensor 414 may detect a motion and a position of the user. As described above, the user may use the setting box 410 as a cover for hiding. The detection sensors 414 may be provided on the front and rear surfaces, and both sides of the setting box 410 to detect the motion of the user.

The setting box 410 may include a vibration motor 415. When the cover is damaged by the object of the shooting game image projected onto the screen 200, the vibration motor 415 may generate vibration to shake the setting box 410. That is, the vibration motor 415 is housed in the setting box 410 and may produce a vibration effect when an object is fired according to the projected image.

Meanwhile, although not illustrated in the drawings, the setting box 410 may be configured so that the size, height, or position thereof is changed according to the contents of the shooting game selected by the user or the progress of the contents.

The setting box 410 may have a control lever 416 and a button 417 on an upper portion thereof.

The control lever 416 may be a joystick. The user may aim the aiming target projected onto the screen 200 by operating the control lever 416. In this case, the aiming state may be confirmed through a head-up display (HUD), which will be described below.

The button 417 may be pressed by the user, thereby sending an instruction to attack the aiming target. For example, when an enemy helicopter or an enemy drone appears on the screen 200 as the object, if the user operates the control lever 416 to aim and then presses the button 417, a missile or anti-aircraft shell is fired to attack the enemy helicopter or the enemy drone.

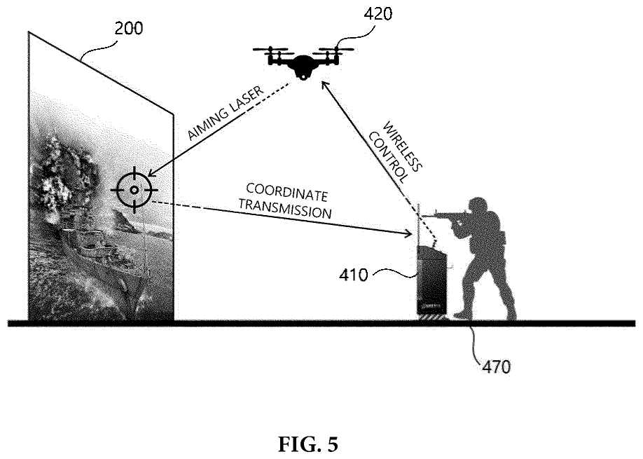

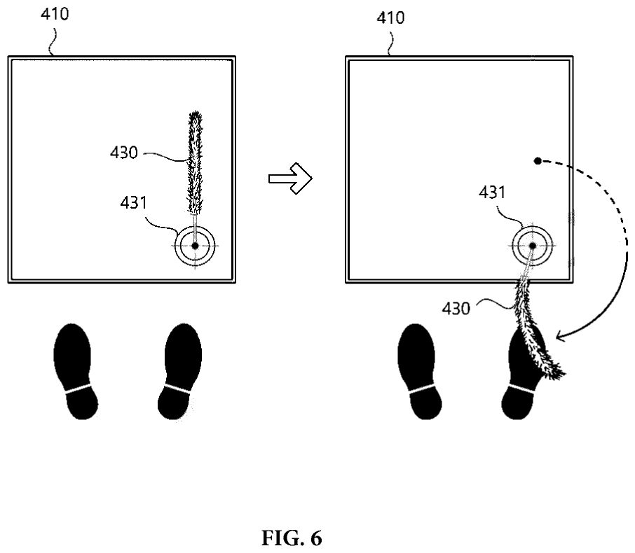

FIG. 5 is a view illustrating aiming using a drone in the 4D screen shooting range according to an embodiment of the present invention, and FIG. 6 is a view illustrating the motion of a brush in the 4D screen shooting range according to an embodiment of the present invention.

Referring to FIG. 5, a drone (not illustrated) may be provided inside the shooting space. The drone may be operated through the control lever 416, the button 417 and the pedal 418. For example, the user turns on the drone and floats it inside the shooting space, operates the control lever 416 to aim the drone at a target on the screen 200 while maintaining hovering, and then presses the button 417 or pedal 418 to be described below, such that the drone attacks the target.

The setting box 410 may be provided with the pedal 418 at a lower side thereof. The pedal 418 is pressed by the user to fire a bullet from the weapon or load bullets into the weapon. However, the user may set for what purpose the weapon will be used in advance, and the firing or loading of bullets into the weapon may be automatically changed according to the contents of the shooting game image projected onto the screen 200.

Referring to FIG. 6, a brush 430 may be disposed on a lower side of the setting box 410. The brush 430 may be rotatably installed at a height corresponding to the user's ankle. In other words, a rotary motor 431 is installed on the lower side of the setting box 410, and the brush 430 is rotatably installed to the rotary motor 431. As the brush 430 rotates, a variety of effects may be produced by touching the user's ankle.

A fog machine 419 may be housed inside the setting box 410. The fog machine 419 may generate a fog. The setting box 410 may have a case composed of a hole-punched plate 419a having punched holes. Accordingly, the fog machine 419 generates a fog according to the contents of the shooting game image projected onto the screen 200, and the fog may be sprayed from the inside of the setting box 410 through the punched holes of the hole-punched plate 419a. For reference, the fog machine 419 may also generate and spray a fog to produce a dust effect. In addition, the generated fog may include a disinfectant solution.

The head-up display 460 is preferably made of a transparent material in a plate shape whose upper portion protrudes upward from one side of the setting box 410. The head-up display 460 may be disposed parallel to any one surface of the wall body 100. In addition, the head-up display 460 may be formed in a curved surface. The user may see the screen 200 through the transparent head-up display 460. When the user operates the control lever 416, aiming at any one object of the images projected onto the screen 200 may be identified or information on the subjects including the aiming object may be identifiably displayed onto the head-up display 460. The head-up display 460 may include at least one pair of acrylic plates spaced apart from each other in parallel. In this case, LED lights 461 may be installed on one side of the setting box 410 between the pair of acrylic plates, so as to be turned on to produce an effect of indicating that the object is fired or a crisis situation occurs with a plurality of colors.

The footrest 470 may be placed on the floor of the shooting zone 400. The footrest 470 may be pressed by a motion of the user. In this case, the user's motion may be movement or cover.

For reference, the footrest 470 may include a panel or a floor plate equipped with a pressure sensor (not illustrated), which will be described below, installed in the shooting zone 400, and a pressure sensor (not illustrated) may be mounted on the floor itself forming the shooting zone 400 to play a role of the footrest 470.

In addition, the footrest 470 may include a vibrating means (not illustrated). The vibrating means may generate vibration in response to the producing effect of the image projected onto the screen 200. For example, when the image projected onto the screen 200 is a bomb exploding scene, and if vibration is generated by the vibrating means, the user may sense the vibration imparted by the vibrating means. In addition, the vibrating means may generate a vibration even in the scene where a tank passes corresponding thereto in addition to the bomb exploding scene. That is, an embodiment of the present invention may produce realistic situations. Further, by the vibrating means, even in a situation in which the user uses a vehicle or a boat, it is possible to produce vibration according to the situation.

The pressure sensor may be disposed in the footrest 470 or on a lower side of the footrest 470. The pressure sensor may detect a pressing force generated by the user who presses it while moving or covering. That is, the pressure sensor may detect the moving direction or speed of the user. In this case, the image projected onto the screen 200 may be changed in response to the moving direction or speed of the user detected by the pressure sensor. In other words, the motion of the user and viewpoint may be reflected by the pressing force detected by the pressure sensor.

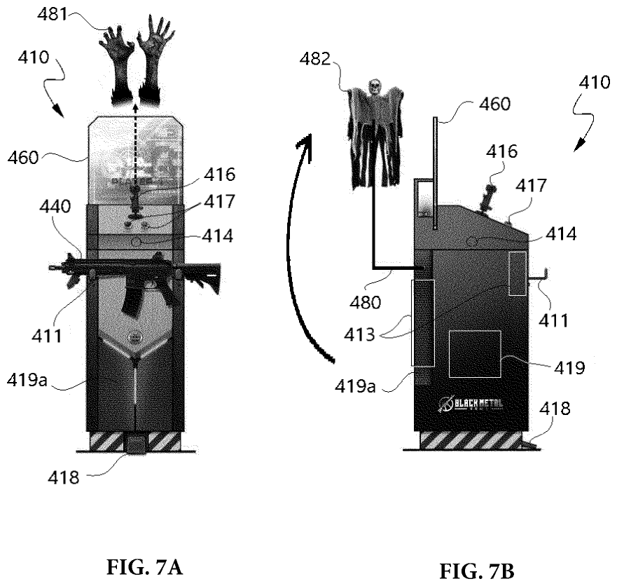

FIGS. 7A and 7B are views illustrating the concept of motion of a rotating structure provided in the setting box installed in the 4D screen shooting range according to an embodiment of the present invention.

Referring to FIG. 7, the setting box 400 may include a rotating table 480, a sliding structure 481 and a rotating structure 482.

The rotating table 480 may be provided on one side of the setting box 400 to rotate the rotating structure 482. The sliding structure 481 shown in FIG. 7A may appear in the user's field of view by sliding vertically with respect to the floor without rotating. Referring to FIG. 7B, the rotating structure 482 is connected to the setting box 400 and rotates in response to a story of the image projected onto the screen 200, thus to be positioned in the user's field of view. Herein, the sliding structure 481 and the rotating structure 482 may be more suitable for the action structure 500 to be described below, and the sliding structure 481 and the rotating structure 482 should be understood by applying mutatis mutandis to the action structure 500 to be described below.

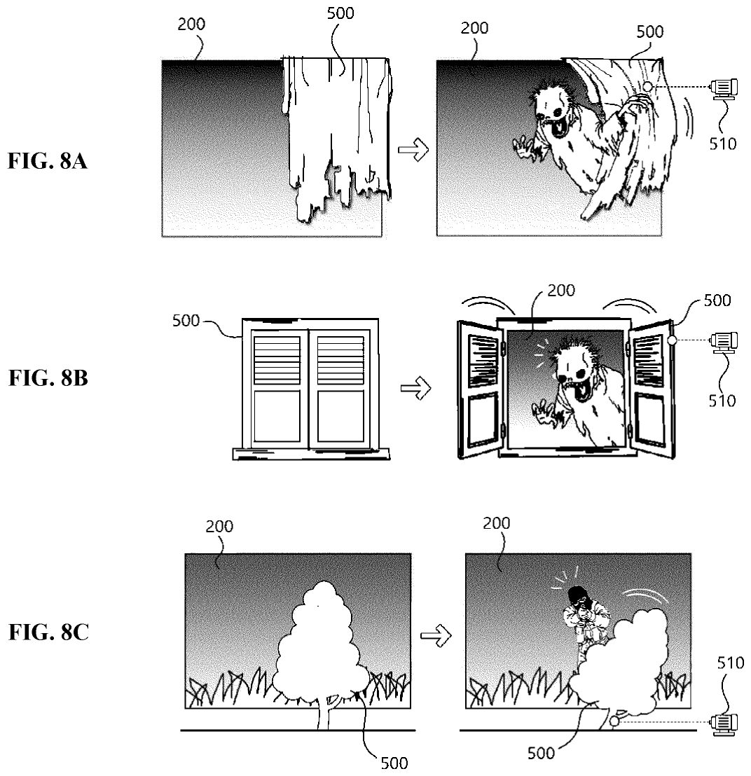

FIGS. 8A to 8C are views illustrating examples of motion of action structures in the 4D screen shooting range according to an embodiment of the present invention.

Referring to FIGS. 8A to 8C, the action structure 500 may be disposed in the shooting space. The action structure 500 may add the producing effect to the shooting game content image selected by the user. For example, the action structure 500 may be all objects around us, such as a tree, branch, weapon box, rock, window, curtain, or the like, and may include different types of objects. In addition, the action structure 500 may be moved, operated, and destroyed according to the contents preset in the shooting game. That is, the action structure 500 may be moved to correspond to the shooting game content image selected by the user by adding a moving means such as a rail (not illustrated), a motor (not illustrated), a wire (not illustrated) and the like.

FIGS. 8A to 8C are views illustrating examples of motion of various action structures in the 4D screen shooting range according to an embodiment of the present invention.

Referring to FIG. 8A, a curtain is placed over a portion of the screen to cover the same as the action structure 500. Herein, a target such as a ghost may appear on the screen 200 at the same time as the curtain of the action structure 500 is folded.

Referring to FIG. 8B, a casement window is installed as the action structure 500. Herein, a target such as a ghost may appear on the screen 200 at the same time as the window of the action structure 500 is opened.

Referring to FIG. 8C, a tree is installed as the action structure 500. In this case, an enemy soldier as the target may appear on the screen as the tree of the action structure 500 is turned over.

In this case, the operation of the above-described action structure 500 may be executed by a servo motor 510.

In addition, although not illustrated in the drawings, various action structures 500 may be applied as an embodiment of the present invention, and may be moved along a rail (not illustrated), a vertical bar (not illustrated) or a horizontal bar (not illustrated).

An embodiment of the present invention may further include an unmanned payment means 600. The unmanned payment means 600 may be disposed inside or outside the shooting space, and the user may pay as a prerequisite for playing the shooting game. For reference, the unmanned payment means 600 disposed outside the shooting space is for payment before performing the shooting game, and the unmanned payment means 600 disposed inside the shooting space is for payment to continuously perform the ended shooting game after the end of the shooting game.

In addition, although not illustrated in the drawings and not described in the present disclosure, according to one embodiment of the present invention, various sensors may be disposed in the shooting range. For example, sensors for detecting the motion of the user such as the detection sensor 414 of the setting box 410 may be provided on the ceiling (not illustrated), the wall body 100, and the floor forming the shooting space, and a sensor (for example, a gyro sensor) may be provided in the personal weapon 440 to display a position indicated by the personal weapon 440 by the user on the screen 200 with infrared light. In addition, according to one embodiment of the present invention, various sensors may be provided in the shooting range, and in one embodiment of the present invention, the user may proceed with more realistic and smooth shooting game contents by utilizing these sensors.

Hereinafter, playing method of using a 4D screen shooting range according to an embodiment of the present invention will be described with reference to the accompanying drawing.

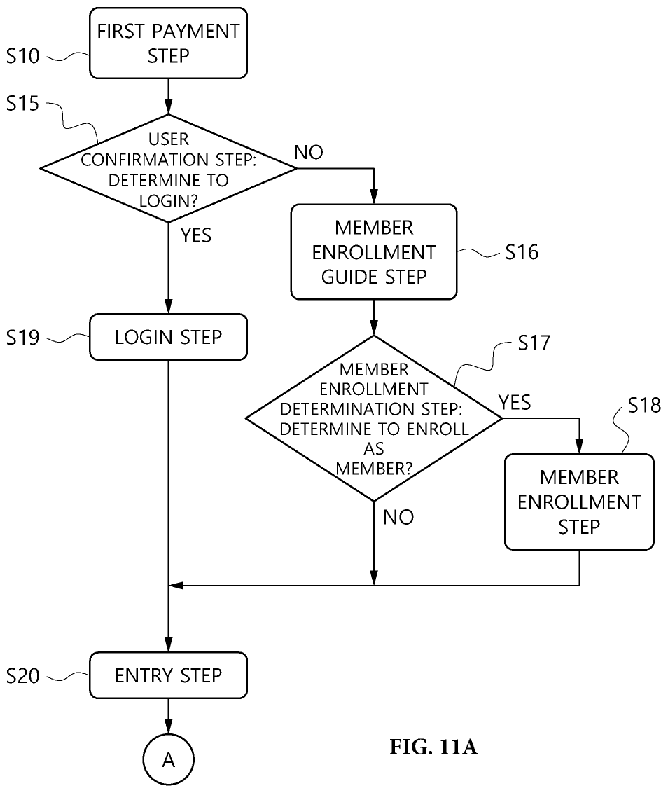

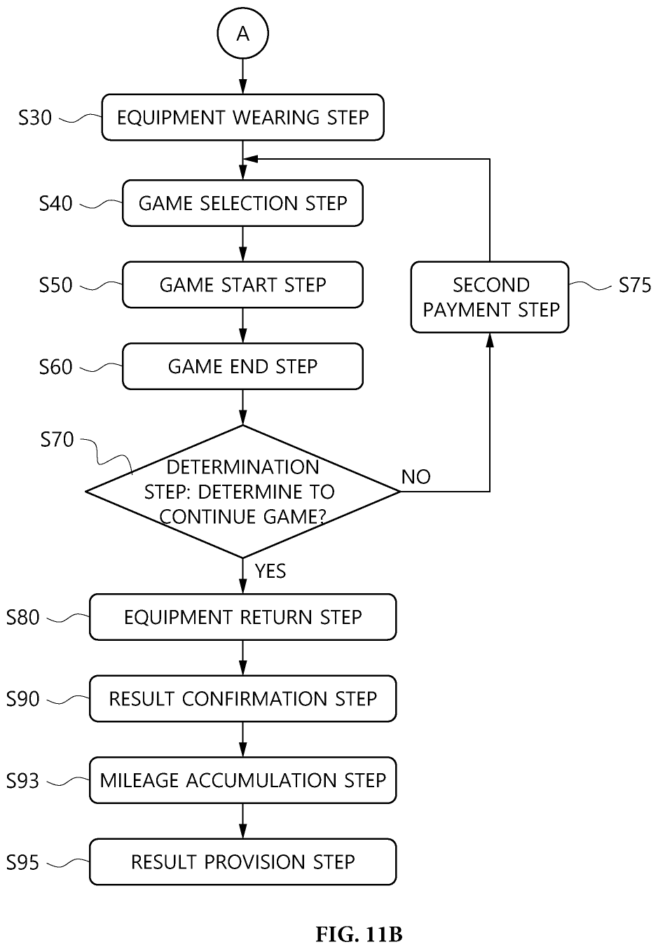

FIGS. 11A and 11B are flowcharts illustrating a procedure of the method of using the 4D screen shooting range according to an embodiment of the present invention.

A first payment step is performed by a user to enter the shooting range and play a screen shooting game through the unmanned payment means 600 provided outside the shooting space (S10). In this case, after payment, the unmanned payment means allows the user to recognize that the payment has been made through a display means or a voice, and may guide the user to enter an empty shooting space among a plurality of shooting spaces.

Next, a user confirmation step is performed to confirm whether the user wants to login through the unmanned payment means (S15).

In this case, if the user wants to proceed with the game in a non-member mode without performing a login, a member enrollment guide step may be performed to guide for enrolling as a member in the unmanned payment means (S16).

Thereafter, a member enrollment determination step may be performed to determine whether the user enrolls as a member (S17).

If the user wants to enroll as the member, a member enrollment step is performed in the unmanned payment means (S18). In this case, when the user enrolls as the member, login may be automatically performed.

If the user wants to login, a login step may be performed in the unmanned payment means (S19).

As described above, if the user wants to proceed with the game without enrolling as a member (S17), the user enrolls as the member (S18), or the user performs login (S19), then an entry step is performed to select and enter an empty shooting space by the user (S20). When the user is located in the shooting zone 400, entry of the user is detected by the detection sensor 414 of the setting box 410 or the pressure sensor (not illustrated) of the footrest 470, and as shown in FIG. 9, an image may be projected onto the screen 200 to select shooting game content. For reference, although not illustrated in the drawings, when the user performs login (S18 or S19), the method may include a step (not illustrated) of providing game information such as level promotion, hunting participation, competition participation, or event benefits of advertisements to the logged in user.

Thereafter, an equipment wearing step is performed to wear equipment arranged in the setting box 410 of the shooting space by the user (S30). That is, the user wears the vibration suit 450 placed on the vibration suit holder 412 of the setting box 410 and holds the personal weapon 440 placed on the personal weapon holder 411 of the setting box 410.

Next, a game selection step is performed to select a shooting game by the user (S40).

In this case, the user may be guided through the image projected onto the screen 200, so as to select the desired shooting game content through the control lever 416 and the button 417 of the setting box 410. Alternately, the desired shooting game content may also be selected by aiming at the image of the screen 200 and pulling the trigger while holding the personal weapon 440 grasped by the user, or the shooting game content may also be selected by pressing the pedal 418. In addition, it may be configured in such a way that, when a predetermined time elapses through countdown during the selection of shooting game content, the shooting game content pointed to at that time is automatically selected, such that a waiting time of users who wait to enter the shooting range at an outside may be reduced.

Thereafter, a game start step is performed to start the shooting game content selected by the user through the button 417 or the trigger of the personal weapon 440 (S50). The user may proceed with the shooting game. For example, the user may be covered through the setting box 410, the game may be performed by operating the control lever 416 and the button 417 of the setting box 410, and vibration may be imparted to the user through the vibration suit 450 or the footrest 470. As described above, since the configuration included in the 4D screen shooting range 10 has been described above, the method of using the components for performing the shooting game will not be described in detail below.

Then, a game end step is performed to end the shooting game (S60), a message for determining whether to continue the game is displayed on the screen 200, and the user determines whether to continue the game in a determination step (S70).

If it is determined that the user wants to continue the shooting game, a second payment step is performed to perform a payment through the unmanned payment means 600 disposed inside the shooting space (S75).

Thereafter, the user may select a shooting game through information projected onto the screen 200 again. For example, the user may continue the ended shooting game, or may select and proceed with a new shooting game content.

However, when the user wants to end the game, an equipment return step is performed to return the equipment worn and held by the user (S80). That is, the user places the worn vibration suit 450 on the vibration suit holder 412, and places the held personal weapon 440 on the personal weapon holder 411. In this case, the vibration suit 450 and the personal weapon 440 are charged in a wired or wireless manner while facing the wireless charging unit 413 of the setting box 410, and the next user may use the personal weapon 440 and the vibration suit 450 without difficulty in performing a shooting game. For reference, the vibration suit 450 and the personal weapon 440 may be provided with a separate power connection means, respectively, when charging in a wired manner, such that the vibration suit 450 and the personal weapon 440 may be connected and charged with the charger through the power connection means.

Thereafter, a result confirmation step may be performed to display results of the shooting game on the screen 200 as shown in FIG. 10, and the user may confirm the results (S90). In addition, the image of the user photographed by the photographing camera 120 may be projected onto the screen 200 in a way that highlights are projected onto the screen. The results of the shooting game and the user's shooting game image photographed by the photographing camera 120 may be stored in a storage unit (not illustrated) provided outside the shooting space.

Thereafter, a mileage accumulation step may be performed to receive and accumulate a mileage corresponding to the results of the game after the game ends by the logged in user (S93). In this case, the mileage may be used to purchase items, converted to free tickets, or exchanged with prizes.

Finally, a result provision step is performed (S95). Therefore, if the user wants to receive the results thereof, the results of the shooting game stored in the storage unit and the shooting game image of the user photographed by the photographing camera 120 may be provided to the user with being stored in a USB or cloud file.

While the preferred embodiment of the present invention has been described above, the above description is merely an embodiment for implementing a 4D screen shooting range and playing method using thereof, and the present invention is not limited to the above-described embodiment, as well as those skilled art to which the present invention pertains will appreciate that various modifications and variations are possible without departing from the gist or spirit of the present invention, and the scope of the present invention will be defined by the appended claims and their equivalents.

### DESCRIPTION OF REFERENCE NUMERALS

10 4D screen shooting range

100 Wall body

110 Entrance

120 Photographing camera

200 Screen

400 Shooting zone

410 Setting box

411 Personal weapon holder

412 Vibration suit holder

413 Wireless charging unit

414 Detection sensor

415 Vibration motor

416 Control lever

417 Button

418 Pedal

419 Fog machine

419a Hole-punched plate

420 Drone

430 Brush

431 Rotation motor

440 Personal weapon

450 Vibration suit

460 Head-up display

461 LED light

470 Footrest

480 Rotating table

481 Sliding structure

482 Rotating structure

500 Action structure

510 Servo motor

600 Unmanned payment means

What is claimed is:

1. A 4D screen shooting range comprising:
a wall body which comprises wall surfaces, a ceiling and a floor to form a shooting space having a predetermined size, and has an entrance formed in any portion of the wall surface;
a screen installed on the wall body by avoiding the entrance and aimed or pointed at with a personal weapon held by a user;
a projection unit configured to project an image onto the screen according to a shooting game content selected by the user;
a shooting zone formed by including a center of the shooting space on the floor in a predetermined size with being spaced apart from the screen, in which a setting box operated to set a shooting game according to a selection of the user is disposed; and
an action structure disposed in the shooting space to add a producing effect to a shooting game content image selected by the user.

2. The 4D screen shooting range according to claim 1, wherein the setting box plays a role of a cover for the user when performing the shooting game.

3. The 4D screen shooting range according to claim 1, wherein the setting box comprises:
a detection sensor configured to detect a motion and a position of the user; and
a vibration motor housed inside to produce a vibration effect when an object is fired according to the projected image.

4. The 4D screen shooting range according to claim 1, wherein the setting box is changed in a size, height, or position according to the contents of the shooting game selected by the user or the progress of the contents.

5. The 4D screen shooting range according to claim 1, wherein the setting box comprises:
a control lever configured to aim an aiming target projected onto the screen;
a button configured to send an instruction to attack the aiming target when being pressed by the user; and
a head-up display made of a transparent material in a plate shape and disposed parallel to any one surface of the wall body, such that the user sees the screen, wherein aiming at any one object of the images projected onto the screen is identified through the control lever or information on subjects including the aiming object is identifiably displayed thereon.

6. The 4D screen shooting range according to claim 5, wherein the head-up display comprises: at least one pair of acrylic plates spaced apart from each other in parallel; and
LED lights installed on one side of the setting box between the pair of acrylic plates, so as to be turned on to produce an effect of indicating that the object is fired or a crisis situation occurs with a plurality of colors.

7. The 4D screen shooting range according to claim 5, further comprising a drone which is disposed in the shooting space and operated through a control lever and a button.

8. The 4D screen shooting range according to claim 7, wherein the operation of the drone using the control lever and the button is identified by the user through the head-up display.

9. The 4D screen shooting range according to claim 1, wherein the setting box comprises a pedal which is formed at a lower side thereof and pressed by the user to fire a bullet from the weapon or load bullets into a weapon.

10. The 4D screen shooting range according to claim 1, wherein the setting box further comprises, at the lower side thereof:
a brush installed at a height corresponding to a user's ankle and configured to touch the user's ankle by rotating; and
a brush rotation motor connected to rotate the brush.

11. The 4D screen shooting range according to claim 1, the setting box further comprises:
a hole-punched plate in which punched holes are formed in any portion thereof; and
a fog machine provided inside the setting box to generate a fog for producing a dispersion effect of dust or fog, wherein the fog is sprayed through the punched holes.

12. The 4D screen shooting range according to claim 1, wherein the shooting zone comprises:
a footrest disposed on the floor and pressed according to the motion of the user; and
a pressure sensor disposed in the footrest or on a lower side of the footrest to detect a moving direction or a speed of the user.

13. The 4D screen shooting range according to claim 12, wherein the image projected onto the screen is changed in response to the moving direction or the speed of the user detected by the pressure sensor, thus to reflect the motion and a viewpoint of the user.

14. The 4D screen shooting range according to claim 1, wherein the personal weapon comprises:
a button or a selector lever operated by the user to select and change firing types in response to a plurality of weapons included in the shooting game contents.

15. The 4D screen shooting range according to claim 1, further comprising:
a photographing camera installed on any portion of the wall body to photograph a game process of the user; and
a storage unit provided outside the shooting space to store an image photographed by the photographing camera.

16. The 4D screen shooting range according to claim 1, wherein the action structure includes different types of structures, and is moved, operated and destroyed according to preset contents in the shooting game.

17. Playing method of using a 4D screen shooting range, the method comprising:
a first payment step of performing a payment through an unmanned payment means;
an entry step of entering a shooting space after the first payment step;
an equipment wearing step of acquiring and wearing a vibration suit and a personal weapon disposed in a setting box after the entry step;
a game selection step of selecting any one of shooting game contents prepared through the setting box after the equipment wearing step;
a game start step of executing the selected shooting game and starting to play the game by a user after the game selection step;
a game end step of ending the shooting game after the game starting step;
an equipment return step of placing the vibration suit and personal weapon in the setting box after the game end step;
a result confirmation step of visually confirming results of the shooting game after the equipment return step; and
a result provision step of providing an image and results of the shooting game after the result confirmation step.

18. The method according to claim 17, further comprising a user confirmation step of confirming whether the user wants to login between the first payment step and the entry step.

19. The method according to claim 17, further comprising a determination step of determining whether to continue or stop the shooting game after the game end step.

20. The method according to claim 17, further comprising a mileage accumulation step of receiving and accumulating a mileage corresponding to the results of the game after the game ends by the logged in user;
wherein the mileage is used to purchase items, converted to free tickets, or exchanged with prizes.
